(19) United States
(12) Patent Application Publication
(10) Pub. No.: US 2021/0345536 A1
(43) Pub. Date: Nov. 11, 2021

(54) PLUG DETECTION SYSTEM FOR AN AGRICULTURAL IMPLEMENT

(71) Applicant: CNH Industrial America LLC, New Holland, PA (US)

(72) Inventors: Seth M. Bich, Newmanstown, PA (US); Robin Michael Pritz, Womelsdorf, PA (US); Paul S. Martin, Ephrata, PA (US)

(73) Assignee: CNH Industrial America LLC, New Holland, PA (US)

(21) Appl. No.: 17/314,589

(22) Filed: May 7, 2021

Related U.S. Application Data
(60) Provisional application No. 63/021,430, filed on May 7, 2020.

(51) Int. Cl. A01B 71/08; G01V 8/10; A01B 61/00

(52) U.S. Cl. CPC A01B 71/08; A01B 61/00; G01V 8/10

(57) ABSTRACT

An agricultural assembly that includes an autonomous or semi-autonomous agricultural vehicle, an agricultural implement connected to the agricultural vehicle, and a plug detection system. The plug detection system includes at least one sensor connected to the agricultural implement for sensing an operational variable and a controller operably connected to the at least one sensor. The controller is configured for detecting a plugged state of the agricultural implement, in which matter hinders operation of the agricultural implement, dependent upon the operational variable of the agricultural implement.

### CROSS REFERENCE TO RELATED APPLICATION

This application claims the benefit of U.S. Provisional Patent Application No. 63/021,430, entitled PLUG DETECTION SYSTEM FOR AN AGRICULTURAL IMPLEMENT and filed May 7, 2020, the contents of which are incorporated herein by reference.

### BACKGROUND OF THE INVENTION

The present invention pertains to agricultural implements and, more specifically, to a plug detection system for an agricultural implement.

Farmers utilize a wide variety of tillage implements to prepare soil for planting. For example, a strip tillage implement is capable of tilling soil in strips along the intended planting rows, moving residue to the areas in between rows, and preparing the seedbed of the strip in preparation for planting. As another example, a field cultivator is capable of simultaneously tilling soil and leveling the tilled soil in preparation for planting.

A tillage implement typically includes a frame that carries a number of ground-engaging tools. The tools may include shanks, shovels, knives, points, sweeps, coulters, spikes, or plows. Each tool performs a function intended to ultimately convert compacted soil into a level seedbed with a consistent depth for providing desirable conditions for planting crops. A tillage implement may additionally include, or be connected with, other devices for inserting fertilizer following the passage of the cultivator shanks, closing the furrow created by the cultivator shanks, or breaking up the clods to create the uniform seedbed. For example, the tillage implement may be connected to an air cart which carries and injects fertilizer into the field.

Often, an implement will become plugged or jammed by soil, debris, or trash as it is towed through the field. As can be appreciated, such plugging may result in the suboptimal performance of the implement and/or the towing vehicle. For instance, a plugged implement may lead to uneven surfaces and/or seedbeds in the field. After noticing that the implement has become plugged, the operator may subsequently adjust the depth of the ground-engaging tools and/or manually remove the soil buildup in order to unplug or unjam the implement. However, the issues associated with a plugged implement may become exacerbated if the operator is unskilled. Furthermore, in relation to autonomous agricultural vehicles, it may be impossible to detect whether the implement has become plugged as the vehicle is operated without direct supervision from an operator.

What is needed in the art is a cost-effective plug detection system for detecting whether the implement has become plugged by a buildup of soil, debris, or trash.

### SUMMARY OF THE INVENTION

In one exemplary embodiment formed in accordance with the present invention, there is provided an autonomous or semi-autonomous agricultural assembly. The agricultural assembly includes an autonomous or semi-autonomous agricultural vehicle, an agricultural implement connected to the agricultural vehicle, and a plug detection system for autonomously detecting and dislodging soil buildup on and/or around the agricultural implement. The plug detection system includes at least one sensor and a controller. The at least one sensor is configured for sensing an operational variable of the agricultural implement. The controller is operably connected to the at least one sensor. The controller is configured for detecting a plugged state of the agricultural implement dependent upon the operational variable of the agricultural implement.

In another exemplary embodiment formed in accordance with the present invention, there is provided an agricultural assembly. The agricultural assembly includes an autonomous or semi-autonomous agricultural vehicle and an agricultural implement connected to the agricultural vehicle. The agricultural implement is configured for being towed by the agricultural vehicle. The agricultural implement includes a frame and a plurality of ground-engaging tools connected to the frame. The agricultural assembly also includes a plug detection system. The plug detection system includes at least one sensor connected to the agricultural implement. The at least one sensor is configured for sensing an operational variable of the agricultural implement. The plug detection system also includes a controller operably connected to the at least one sensor. The controller is configured for detecting a plugged state of the agricultural implement, in which matter hinders operation of the agricultural implement, dependent upon the operational variable of the agricultural implement.

In yet another exemplary embodiment formed in accordance with the present invention, there is provided a method for operating an agricultural assembly. The method includes an initial step of providing an autonomous or semi-autonomous agricultural vehicle and an agricultural implement connected to the agricultural vehicle. The agricultural implement is configured for being towed by the agricultural vehicle. The agricultural implement includes a frame and a plurality of ground-engaging tools connected to the frame. The agricultural assembly also includes a plug detection system. The plug detection system includes at least one sensor connected to the agricultural implement and a controller operably connected to the at least one sensor. The method also includes a step of sensing, by the at least one sensor, an operational variable of the agricultural implement. The method further includes a step of detecting, by the controller, a plugged state of the agricultural implement, in which matter hinders operation of the agricultural implement, dependent upon the operational variable of the agricultural implement.

One possible advantage of the exemplary embodiment of the plug detection system is that the state of the agricultural implement may be automatically detected without supervision from an operator.

Another possible advantage of the exemplary embodiment of the plug detection system is that the agricultural implement may be automatically unplugged without intervention from an operator.

### BRIEF DESCRIPTION OF THE DRAWINGS

For the purpose of illustration, there are shown in the drawings certain embodiments of the present invention. It should be understood, however, that the invention is not limited to the precise arrangements, dimensions, and instruments shown. Like numerals indicate like elements throughout the drawings. In the drawings:

FIG. 1 illustrates a perspective view of an exemplary embodiment of an autonomous or semi-autonomous agricultural assembly, the assembly including an autonomous or semi-autonomous agricultural vehicle, an agricultural implement, and a plug detection system, in accordance with an exemplary embodiment of the present invention;

FIG. 2 illustrates a schematic view of the agricultural assembly of FIG. 1;

FIG. 3 illustrates a schematic view of another embodiment of a plug detection system with force sensors, in accordance with an exemplary embodiment of the present invention; and

FIG. 4 illustrates a flowchart of a method for operating an agricultural assembly with the plug detection system of the present invention, in accordance with an exemplary embodiment of the present invention.

### DETAILED DESCRIPTION OF THE INVENTION

The terms “forward”, “rearward”, “left” and “right”, when used in connection with the agricultural tillage implement and/or components thereof are usually determined with reference to the direction of forward operative travel of the agricultural vehicle, but they should not be construed as limiting. The terms “longitudinal” and “transverse” are determined with reference to the fore-and-aft direction of the agricultural tillage implement and are equally not to be construed as limiting. The term “plugged state” of the agricultural implement may refer to a state or condition of the agricultural implement wherein matter, such as soil, debris, trash, or any other unwanted material, has compacted and/or accumulated on or around the frame and/or ground engaging tool(s) of the agricultural implement, which then hinders the operation of any component of the agricultural implement.

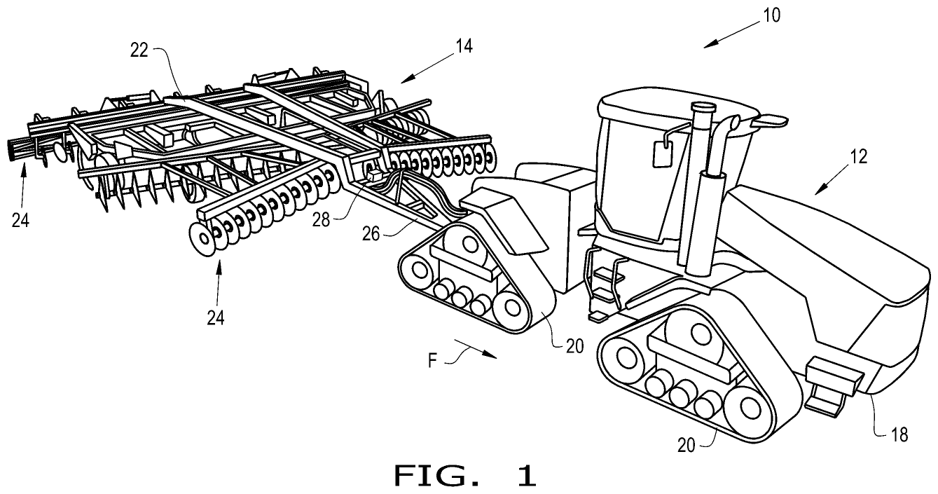

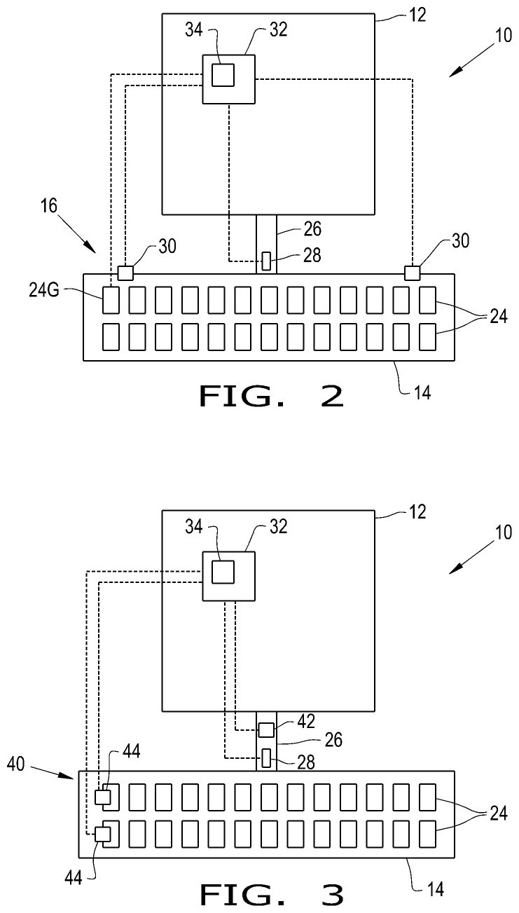

Referring now to the drawings, and more particularly to FIGS. 1-2, there is shown an autonomous or semi-autonomous agricultural assembly 10 that generally includes an autonomous or semi-autonomous agricultural vehicle 12, an agricultural implement 14, and a plug detection system 16.

The autonomous or semi-autonomous agricultural vehicle 12 may generally include a chassis 18, a prime mover, wheels and/or tracks 20, a hitch, and an ISOBUS connection for coupling to the agricultural implement 14 and/or a fertilizer device. The autonomous or semi-autonomous agricultural vehicle 12 may optionally include a cab for housing the operator (unnumbered). The agricultural vehicle 12 may be in the form of any desired agricultural vehicle, such as a tractor, which is fully or at least partially autonomously operated.

The agricultural implement 14 may be towed behind the agricultural vehicle 12 in a forward direction of travel F. The agricultural implement 14 generally includes a frame 22, wheels (unnumbered), various ground-engaging tools 24 mounted to the frame 22, a tongue 26 which connects to the agricultural vehicle 12, and at least one actuator 28 located on the frame 22 for raising and/or lowering the frame 22 in order to adjust the operating depth of the ground-engaging tools 24. The agricultural implement 14 may be in the form of any desired ground-engaging implement, such as a field cultivator, a disk ripper, a fertilizer applicator implement, or a sweep. It should be appreciated that the agricultural implement 14 may also incorporate a fertilizer device and/or a portion thereof.

The frame 22 may be a single body frame or it may be a multi-section frame with one or more wing sections. In addition to supporting the ground-engaging tools 24, the frame 22 may also support hydraulic and electrical systems which can adjust down pressure and/or (un)fold the wing sections. The frame 22 and/or tongue 26 may also support the at least one actuator 28. The frame 22 may comprise any desired material, such as metal.

The ground-engaging tools 24 may include primary and/or secondary tools. For example, the ground-engaging tools 24 may include shank assemblies, a ganged disk harrow, a spike tooth harrow, leveling blades, and/or rolling, i.e., crumbler, basket assemblies for finishing the soil.

The at least one actuator 28 may be connected to the frame 22 and/or tongue 26. The at least one actuator 28 may raise and lower the frame 22 to adjust the operating depth of the ground-engaging tools 24. Furthermore, the agricultural implement 14 may include multiple actuators connected in between the frame 22 and the wheels of the agricultural implement 14 for raising and lowering the depth of the ground-engaging tools 24. Each actuator 28 may be in the form of any desired actuator, such as a hydraulic cylinder.

The plug detection system 16 includes at least one sensor 30 and a controller 32 with a memory 34. The plug detection system 16 automatically detects whether the agricultural implement 14 is plugged. The plug detection system 16 may sense an operational variable of the agricultural implement 14. The plug detection system 16 may also automatically adjust the agricultural vehicle 12 and/or the agricultural implement 14 in order to automatically dislodge the buildup of soil on the agricultural implement 14. It is noted that the plug detection system 16 may not include a speed sensor or an optical camera.

The at least one sensor 30 is connected to the agricultural implement 14. The at least one sensor 30 may be in the form of at least one first conductive sensor element 30 and at least one second conductive sensor element 24G paired with the first conductive sensor element 30. The first and second conductive sensor elements 30, 24G may be connected to the agricultural implement 14 at any desired location. For example, one or more conductive sensor elements 30 may be connected to the frame 22 near the front of the agricultural implement 14 for detecting a buildup of soil in front of the agricultural implement 14. Each first conductive sensor element 30 may be in the form of an electrically isolated probe 30. The probe 30 may extend downwardly from the frame 22 and toward the soil. Generally, the probe 30 may not contact soil unless the agricultural implement 14 has become plugged. Each second conductive sensor element 24G may be in the form of a ground-engaging tool 24G and/or another electrically isolated probe. For instance, the second conductive sensor element 24G can be in the form of one of the existing ground-engaging tools 24G which serves as a grounding point for the plug detection system 16.

The plug detection system 16 may sense an operational variable in the form of a resistance value and/or a capacitance value between the at least one probe 30 and the at least one ground-engaging tool 24G. It should be appreciated that the plug detection system 16 may include only one probe 30 or an array of probes 30 dispersed throughout the agricultural implement 14 for covering one or more areas or sectors that are associated with the ground-engaging tool(s) 24. Furthermore, the plug detection system 16 may include an array of probes with alternating grounding and sensing probes.

If the plug detection system 16 utilizes resistive sensing, then the plug detection system 16 may detect the resistance between the paired sensor elements 30, 24G. In other words, these sensor elements 30, 24G may serve as paired measuring points on the agricultural implement 14. In normal operation, soil will not contact the probe 30, which may accordingly indicate a first sensed resistance value. The first sensed resistance value may be a high, or nearly infinite, resistance value since the circuit remains uncompleted. Upon plugging of the agricultural implement 14, the buildup of soil will rise to contact the probe 30, which may accordingly complete a circuit and indicate a second sensed resistance value between the paired ground-engaging tool 24G and the probe 30. The second sensed resistance value may be lower than the first sensed resistance value. As can be appreciated, prior testing under various weather conditions with different soil types may provide a threshold resistance value, or range thereof, which is indicative of a plugged state of the agricultural implement 14. Thereby, the controller 32 may compare the real-time sensed resistance value to a known threshold resistance value to determine whether the agricultural implement 14 is in a plugged state.

If the plug detection system 16 utilizes capacitive sensing, then the plug detection system 16 may detect the capacitance between the paired sensor elements 30, 24G. In other words, the sensor elements 30, 24G may function as capacitor plates, while the medium between the sensor elements 30, 24G, i.e., soil, functions as the capacitor dielectric. As discussed above, one or more of the existing ground-engaging tools 24G may serve as the grounding point. Thereby, when the buildup of soil, on or around one or more of the ground-engaging tools 24G, rises to engage with the probe(s) 30, the capacitive circuit will be completed; thus, indicating a plugged state of the agricultural implement 14.

The controller 32 is operably connected to the at least one sensor 30, 24G and the at least one actuator 26. The controller 32 may also be connected to any other desired component of the agricultural vehicle 12 and/or agricultural implement 14. For instance, the controller 32 may also be additionally connected to a speed sensor of the agricultural vehicle 12, a global positioning system (GPS) location sensor, and/or any other desired sensor. The controller 32 may detect a plugged state of the agricultural implement 14 by indirectly determining a level of soil buildup during operation of the agricultural implement 14. The controller 32 may indirectly determine the level of soil buildup by sensing one or more operational variables of the agricultural implement 14 and subsequently comparing the sensed operational variable to a known threshold operational variable which may be stored in the memory 34. The controller 32 may automatically adjust the depth of the agricultural implement 14, the rate of the fertilizer, the type of fertilizer, a speed or direction of the agricultural vehicle 12, and/or any other desired parameter. The controller 32 may be a standalone controller or incorporated into any desired existing hardware and/or software of the agricultural vehicle 12 and/or agricultural implement 14.

Referring now specifically to FIG. 3, there is shown another embodiment of a plug detection system 40. The plug detection system 40 may be substantially similar as the plug detection system 16, except that the plug detection system 40 includes at least one sensor 42, 44 in the form of at least one force sensor 42, 44. The force sensors 42, 44 may be connected to the controller 32. The force sensors 42, 44 may also be connected to the frame 22 of the agricultural implement 14 at any desired location. For example, one or more force sensors 42 may be connected to the tongue 26 and/or hitch of the agricultural vehicle 12. Additionally or alternatively, one or more force sensors 44 may be directly connected to one or more ground-engaging tools 24.

Each force sensor 42, 44 may sense an operational variable in the form of a frame load which is indicative of an amount of soil buildup on or around the agricultural implement 12. Each sensor 42, 44 will then provide the controller 32 with this sensed frame load. The force sensors 42, 44 may be in the form of load sensors and/or strain gauges. In operation, the controller 32 may accordingly compare the sensed frame load with a known threshold frame load which is stored in the memory 34. If the sensed frame load exceeds the threshold frame load, then the controller 32 may indicate that the agricultural implement 14 is in a plugged state. It should be appreciated that normal frame loads, i.e., non-plugged frame loads, may be recorded by the controller 32 for use as a baseline during operation of the agricultural implement 14.

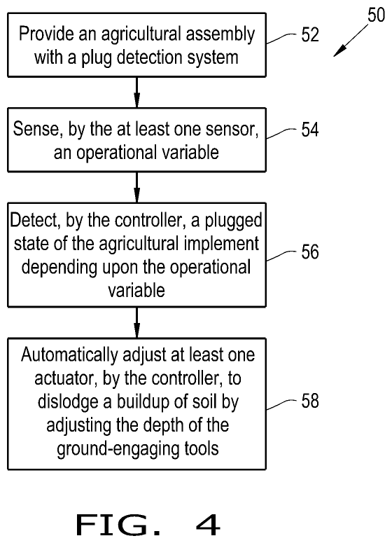

Referring now to FIG. 4, there is shown a flowchart of a method 50 for operating an agricultural assembly 10 with the plug detection system 16, 40 as described above. The method 50 includes an initial step of providing the agricultural assembly 10 (at block 52). The method 50 may then include sensing, by the at least one sensor 30, 24G, 42, 44, an operational variable of the agricultural implement 14 (at block 54). Therein, the plug detection system 16, 40 may sense the resistance and/or capacitance between two points on the agricultural implement 14 and/or a load being applied onto the agricultural implement 14. The method 50 may also include detecting, by the controller 32, a plugged state of the agricultural implement 14 dependent upon the operational variable (at block 56). The controller 32 may detect a plugged state of the agricultural implement 14 by comparing the operational variable which is sensed by the at least one sensor 30, 24G, 42, 44 to a known threshold operational variable in order to indirectly determine a level of soil buildup. If a plugged state is detected, then the method 50 may further include automatically adjusting the at least one actuator 28 to dislodge a buildup of soil by adjusting the depth of the ground-engaging tools 24 (at block 58). The controller 32 may conduct multiple attempts to raise and/or lower the agricultural implement 14 in order to clear the soil buildup. The controller 32 may also notify an operator and/or a control center of the plugged state of the agricultural implement 14. If the plug persists, the controller 32 may stop the agricultural implement 12 and cease operation thereof until an operator manually clears the soil buildup from the agricultural implement 14. Once the soil buildup has been removed, the controller 32 may direct the agricultural vehicle 12 to proceed with its normal operation.

It is to be understood that the steps of the method 50 is performed by the controller 32 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the controller 32 described herein, such as the method 50, is implemented in software code or instructions which are tangibly stored on a tangible computer readable medium. The controller 32 loads the software code or instructions via a direct interface with the computer readable medium or via a wired and/or wireless network. Upon loading and executing such software code or instructions by the controller 32, the controller 32 may perform any of the functionality of the controller 32 described herein, including any steps of the method 50 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

These and other advantages of the present invention will be apparent to those skilled in the art from the foregoing specification. Accordingly, it is to be recognized by those skilled in the art that changes or modifications may be made to the above-described embodiments without departing from the broad inventive concepts of the invention. It is to be understood that this invention is not limited to the particular embodiments described herein, but is intended to include all changes and modifications that are within the scope and spirit of the invention.

1. An agricultural assembly, comprising:
an autonomous or semi-autonomous agricultural vehicle;
an agricultural implement connected to the agricultural vehicle, the agricultural implement being configured for being towed by the agricultural vehicle, the agricultural implement comprising a frame and a plurality of ground-engaging tools connected to the frame; and
a plug detection system, comprising:
at least one sensor connected to the agricultural implement, the at least one sensor being configured for sensing an operational variable of the agricultural implement; and
a controller operably connected to the at least one sensor, the controller being configured for detecting a plugged state of the agricultural implement, in which matter hinders operation of the agricultural implement, dependent upon the operational variable of the agricultural implement.

2. The agricultural assembly of claim 1, wherein the controller is configured for detecting the plugged state by comparing the operational variable which is sensed by the at least one sensor to a known threshold operational variable to indirectly determine a level of soil buildup.

3. The agricultural assembly of claim 1, wherein the at least one sensor comprises at least one first sensor element and at least one second sensor element paired with the at least one first sensor element.

4. The agricultural assembly of claim 3, wherein the at least one first sensor element is in the form of at least one probe and the at least one second sensor element is in the form of at least one ground-engaging tool.

5. The agricultural assembly of claim 4, wherein the plug detection system is configured for sensing an operational variable in the form of a resistance value sensed between the at least one probe and the at least one ground-engaging tool, and wherein the controller is configured for detecting the plugged state of the agricultural implement upon the probe contacting soil and registering a corresponding sensed resistance value.

6. The agricultural assembly of claim 4, wherein the plug detection system is configured for sensing an operational variable in the form of a capacitance value sensed between the at least one probe and the at least one ground-engaging tool, and wherein the controller is configured for detecting the plugged state of the agricultural implement upon the probe contacting soil and registering a corresponding sensed capacitance value.

7. The agricultural assembly of claim 1, wherein the at least one sensor comprises at least one force sensor, the force sensor being configured for sensing an operational variable in the form of a frame load.

8. The agricultural assembly of claim 7, wherein the at least one force sensor comprises at least one of at least one load sensor and at least one strain gauge.

9. The agricultural assembly of claim 1, wherein the agricultural implement further comprises at least one actuator configured for raising and lowering the agricultural implement to adjust a depth of the ground-engaging tools.

10. The agricultural assembly of claim 9, wherein the controller is configured for automatically adjusting the at least one actuator to dislodge a buildup of soil upon detecting that the agricultural implement is in the plugged state.

11. A method for operating an agricultural assembly, comprising:
providing an autonomous or semi-autonomous agricultural vehicle, an agricultural implement connected to the agricultural vehicle, the agricultural implement being configured for being towed by the agricultural vehicle, the agricultural implement comprising a frame and a plurality of ground-engaging tools connected to the frame, and a plug detection system comprising at least one sensor connected to the agricultural implement and a controller operably connected to the at least one sensor;
sensing, by the at least one sensor, an operational variable of the agricultural implement; and
detecting, by the controller, a plugged state of the agricultural implement, in which matter hinders operation of the agricultural implement, dependent upon the operational variable of the agricultural implement.

12. The method of claim 11, wherein the step of detecting the plugged state of the agricultural implement comprises comparing, by the controller, the operational variable which is sensed by the at least one sensor to a known threshold operational variable to indirectly determine a level of soil buildup.

13. The method of claim 11, wherein the at least one sensor comprises at least one first sensor element and at least one second sensor element paired with the at least one first sensor element.

14. The method of claim 13, wherein the at least one first sensor element is in the form of at least one probe and the at least one second sensor element is in the form of at least one ground-engaging tool.

15. The method of claim 14, wherein the operational variable is in the form of a resistance value sensed between the at least one probe and the at least one ground-engaging tool, and wherein the controller is configured for detecting the plugged state of the agricultural implement upon the probe contacting soil and registering a corresponding sensed resistance value.

16. The method of claim 14, wherein the operational variable is in the form of a capacitance value sensed between the at least one probe and the at least one ground-engaging tool, and wherein the controller is configured for detecting the plugged state of the agricultural implement upon the probe contacting soil and registering a corresponding sensed capacitance value.

17. The method of claim 11, wherein the at least one sensor comprises at least one force sensor, the force sensor being configured for sensing a frame load.

18. The method of claim 17, wherein the at least one force sensor comprises at least one of at least one load sensor and at least one strain gauge.

19. The method of claim 11, wherein the agricultural implement further comprises at least one actuator configured for raising and lowering the agricultural implement to adjust a depth of the ground-engaging tools.

20. The method of claim 19, further comprising a step of automatically adjusting the at least one actuator, by the controller, to dislodge a buildup of soil upon detecting that the agricultural implement is in the plugged state.
